(19) United States
(12) Patent Application Publication
(10) Pub. No.: US 2012/0177775 A1
(43) Pub. Date: Jul. 12, 2012

(54) TORPEDOES

(75) Inventor: Kensuke SUENAMI, Toyota-shi (JP)

(73) Assignee: KOJIMA PRESS INDUSTRY CO., LTD., Toyota-shi (JP)

(21) Appl. No.: 13/347,167

(22) Filed: Jan. 10, 2012

(30) Foreign Application Priority Data
Jan. 11, 2011 (JP) 2011002923
Jan. 18, 2011 (JP) 2011008110

(51) Int. Cl. B29C 45/20; B29C 45/30

(52) U.S. Cl. 425/564

(57) ABSTRACT

In one aspect of the present teachings, a torpedo includes a body and a needle pin. The body may have a plurality of blades formed on an outer circumferential surface of the body. The needle pin is received within the body and is axially movable to extend from and retract into a front portion of the body. The plurality of blades may be arranged to ensure a gap between the outer circumferential surface of the body and an inner circumferential wall of an internal space of a nozzle case for receiving a supply of a molten material when the body is received within the internal space. The blades may be formed separately each other.

### CROSS-REFERENCES TO RELATED APPLICATIONS

This application claims priority to Japanese Patent Application Serial Number 2011-2923 filed Jan. 11, 2011 and Japanese Patent Application Serial Number 2011-8110 filed Jan. 18, 2011, the contents of which are both incorporated herein by reference.

### BACKGROUND OF THE INVENTION

1. Field of the Invention

The present invention relates to torpedoes, and in particular to torpedoes having a substantially cylindrical body and a needle pin movable into and out of a tip end of the cylindrical body in an axial direction of the cylindrical body.

2. Description of the Related Art

A known torpedo is configured to be assembled within a nozzle case that is mounted to a mold. A needle pin of the torpedo opens a gate communicating with a cavity of the mold when a pressure of a molten resin, which is melted from pellets and fed into a gap defined between the outer circumferential surface of a cylindrical body of the torpedo and the inner wall of the nozzle case, exceeds a predetermined pressure. Japanese Laid-Open Patent Publication No. 2005-246951 discloses a torpedo having a blade in a spiral form formed on an outer circumferential surface of the cylindrical body for improving the plasticization efficiency of pellets. When the torpedo is assembled within the nozzle case, the blade serves to ensure a gap between the outer circumferential surface of the cylindrical body and an inner wall of the nozzle case.

However, in order to form the blade into a spiral form as in the above publication, it requires a troublesome and costly machining work.

Therefore, there has been a need in the art for a further improved torpedo.

### SUMMARY OF THE INVENTION

According to one aspect of the present teachings, a torpedo includes a body and a needle pin. The body has a plurality of blades formed on an outer circumferential surface of the body. The needle pin is received within the body and is axially movable to extend from and retract into a front portion of the body. The plurality of blades are arranged to ensure a gap between the outer circumferential surface of the body and an inner circumferential wall of an internal space of a nozzle case for receiving a supply of a molten material when the body is received within the internal space. The blades are formed separately each other.

According to another aspect of the present teachings, a torpedo includes a body and a needle pin received within the body and axially movable relative to the body. The needle pin has at least one stepped portion for receiving a pressure of a molten material to produce a force for moving the needle pin in an axial direction when the body is received within a nozzle case into which the molten material is supplied.

### BRIEF DESCRIPTION OF THE DRAWINGS

FIG. 1 is a perspective view of a torpedo according to a first example,

FIG. 2 is a side view of the torpedo;

FIG. 3 is a front view of the torpedo;

FIG. 4 is a sectional view showing the torpedo assembled within a nozzle case of a direct molding machine;

FIG. 5 is a view similar to FIG. 4 but showing the state where a molten resin is injected into the nozzle case;

FIG. 6 is a perspective view of a torpedo according to a second example,

FIG. 7 is a side view of the torpedo shown in FIG. 6;

FIG. 8 is a front view of the torpedo shown in FIG. 6;

FIG. 9 is a sectional view showing the torpedo assembled within a nozzle case of a direct molding machine; and

FIG. 10 is a view similar to FIG. 9 but showing the state where a molten resin is injected into the nozzle case.

### DETAILED DESCRIPTION OF THE INVENTION

Each of the additional features and teachings disclosed above and below may be utilized separately or in conjunction with other features and teachings to provide improved torpedoes. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful examples of the present teaching.

In one example, a torpedo includes a body having a substantially cylindrical configuration and a plurality of blades formed on an outer circumferential surface of the body. The plurality of blades are arranged to ensure a gap between the outer circumferential surface of the body and an inner circumferential wall of an internal space of a nozzle case when the body is received within the internal space of the nozzle case. The torpedo further includes a needle pin received within the body and axially movable to extend from and retract into a front portion of the body. When a pressure of a molten resin melted from pellets fed into the gap exceeds a predetermined pressure, the needle pin can open a gate of a mold mounted to the nozzle case. The mold defines a cavity communicating with the gate. The plurality of blades include a first group of blades and a second group of blades. The first group of blades is positioned on one side with respect to a middle position in an axial direction of the body. The blades in the first group are spaced substantially equally from each other in a circumferential direction of the body. The second group of blades is positioned on the other side with respect to the middle position. The blades in the second group are spaced substantially equally from each other in the circumferential direction of the body and are positioned to be displaced in the circumferential direction from the blades in the first group.

With this arrangement, the pellets fed into the gap can contact with many of the blades, and therefore, it is possible to increase a contact area of the blades with the pellets. Hence, it is possible to increase the pressure that may be received by the pellets, so that plasticization efficiency of the pellets can be improved. For example, the blades may be formed to extend linearly in the axial direction of the body. With this arrangement, the blades can be easily formed.

The needle pin may have at least one stepped portion that can receive the pressure of the molten resin to produce a force for moving the needle pin in a direction for opening the gate. With this arrangement, the gate communicating with the cavity can be easily smoothly opened even in the case that a pressure of molten resin is relatively small or even in the case that the size of an injection device, such as a plunger, for producing the injection pressure is relatively small.

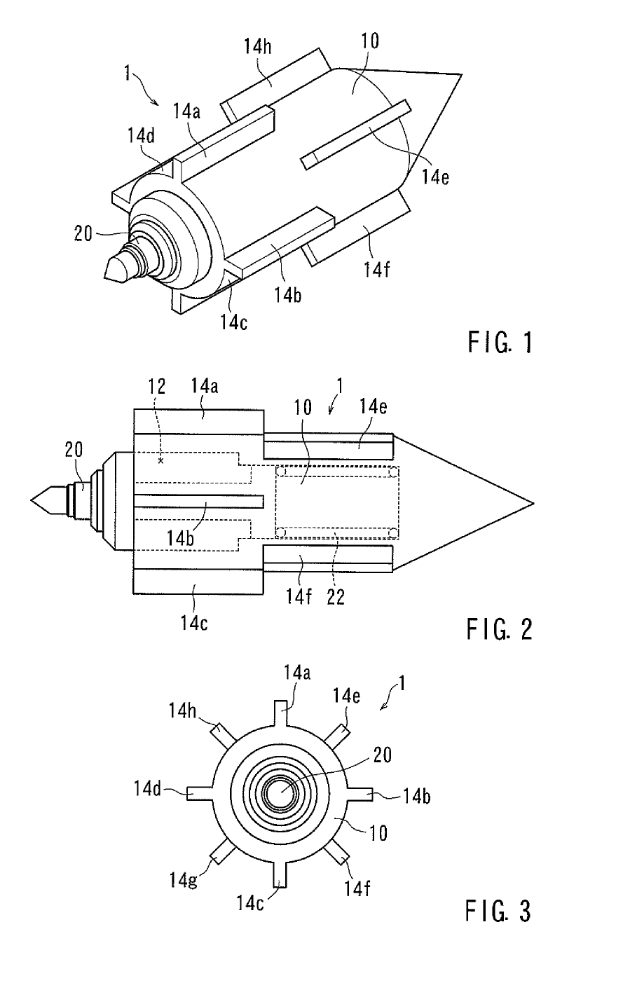

Representative examples will now be described with reference to FIGS. 1 to 10.

### First Example

A first example will now be described with reference to FIGS. 1 to 5. Referring to FIGS. 1 to 4, there are shown a torpedo 1 serving as an injection device for a direct molding machine (not shown), a nozzle case 2 into which the torpedo 1 can be assembled, and a mold 3 mounted to a front end of the nozzle case 2.

The torpedo 1 will be first described. The torpedo 1 has a substantially cylindrical body 10 and a needle pin 20. The needle pin 20 is axially movably received within the cylindrical body 10 and can extend from and retreat into a front end of the cylindrical body 10.

As shown in FIGS. 1 and 2, a bottomed insertion hole 12 is formed within the front end portion (positioned on the side for injecting a molten resin M) of the cylindrical body 10 and extends in the axial direction thereof. The needle pin 20 is axially movably received within the insertion hole 12. A plurality of blades 14 are formed on the outer circumferential surface of the cylindrical body 10. In this example, eight blades 14 including a first blade 14a, a second blade 14b, a third blade 14c, a fourth blade 14d, a fifth blade 14e, a sixth blade 14f, a seventh blade 14g and an eighth blade 14h are formed. Each of the blades 14 has a shape of a flat plate that is rectangular as viewed in the circumferential direction of the cylindrical body 10. Each of the blades 14 extends linearly in the axial direction of the cylindrical body 10 and protrudes radially outwardly from the outer circumferential surface of the cylindrical body 10.

The first to fourth blades 14a to 14d of the eight blades 14 are formed to extend only within a region between the front end and a substantially central position with respect to the axial direction of the cylindrical body 10. In addition, the first to fourth blades 14a to 14d are spaced equally from each other (by an angle of 90°) in the circumferential direction of the cylindrical body 10.

For example, as shown in FIG. 3, the first blade 14a may be positioned to correspond to 0:00 position of the hour hand of a clock, the second blade 14b may be positioned to correspond to 3:00 position of the hour hand, the third blade 14c may be positioned to correspond to 6:00 position of the hour hand, and the fourth blade 14d may be positioned to correspond to 9:00 position of the hour hand.

On the other hand, the fifth to eighth blades 14e to 14h of the eight blades 14 are formed to extend only within a region between the base end (positioned on the side for feeding pellets P) and the substantially central position with respect to the axial direction of the cylindrical body 10. In addition, similar to the first to fourth blades 14a to 14d, the fifth to eighth blades 14e to 14h are spaced equally from each other (by an angle of 90°) in the circumferential direction of the cylindrical body 10.

Further, the fifth blade 14e, the sixth blade 14fr, the seventh blade 14g and the eighth blade 14 are displaced from the first blade 14a, the second blade 14b, the third blade 14c and the fourth blade 14d in the circumferential direction by an angle of 45°, respectively.

Thus, the fifth blade 14e is positioned to correspond to 1:30 position of the hour hand, the sixth blade 14f is positioned to correspond to 4:30 position of the hour hand, the seventh blade 14g is positioned to correspond to 7:30 position of the hour hand, and the eighth blade 14h is positioned to correspond to 10:30 position of the hour hand, in the case that the first blade 14a is positioned to correspond to 0:00 position of the hour hand, the second blade 14b is positioned to correspond to 3:00 position of the hour hand, the third blade 14c is positioned to correspond to 6:00 position of the hour hand, and the fourth blade 14d is positioned to correspond to 9:00 position of the hour hand as described above.

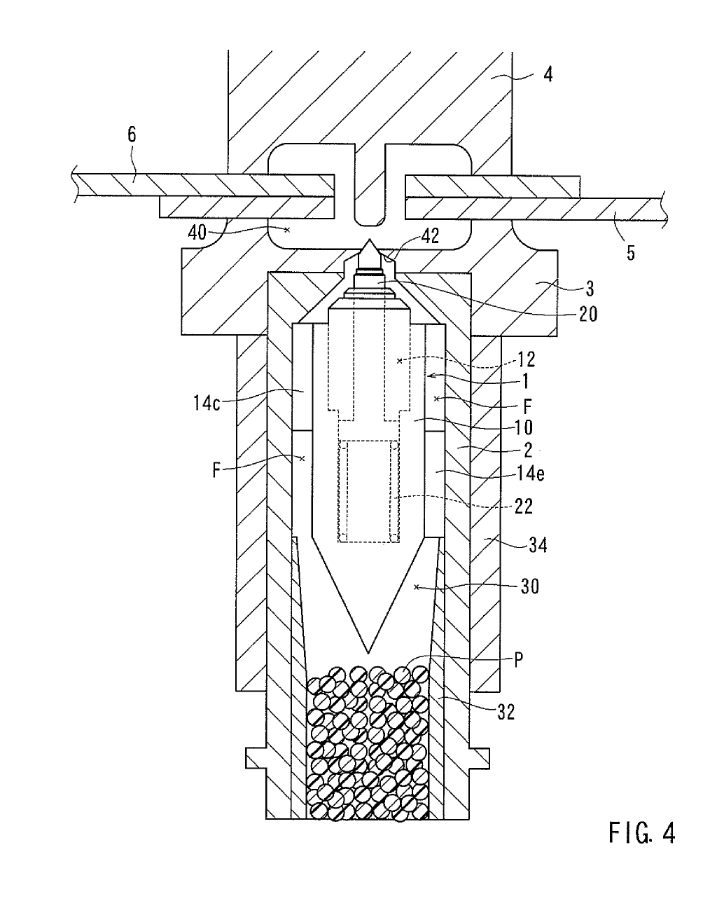

The above eight blades 14 serve as a slide mechanism when the cylindrical body 10 is assembled within an internal space 30 defined in the nozzle case 2 as shown in FIG. 4.

As described above, the eight blades 14 are formed only at 0:00 position, 3:00 position, 6:00 position, 9:00 position, 1:30 position, 4:30 position and 10:00 position of the hour hand. In other words, these blades 14 are not formed to extend throughout the entire circumference (360°) around the cylindrical body 10. Therefore, a gap F is ensured at positions where no blade 14 exists. In this way, the blades 14 are formed such that the gap F is ensured between the inner wall of the internal space 30 of the nozzle case 2 and the outer circumferential surface of the cylindrical body 10.

A portion of the cylindrical body 10 on the side of the base end is tapered, so that the pellets P can be smoothly fed from within the internal space 30 of the nozzle case 2 into the gap F.

As described previously, the needle pin 20 is inserted into the insertion hole 12 formed in the cylindrical body 10. A compression spring 22 is interposed between the base end of the needle pin 20 and the bottom of the insertion hole 12, so that the needle pin 20 is normally biased forwardly (upwardly as viewed in FIG. 4) by the biasing force of the compression spring 22. A removal preventing mechanism (not shown) is provided for preventing the needle pin 20 from being removed from within the insertion hole 12.

The needle pin 20 is sized such that the front end of the needle pin 20 can close a gate 42 of the mold 3 for preventing flow of the molten resin M from the gate 42 during a normal condition (i.e., during the time when the pellets P are not pushed by a plunger (not shown)) when the cylindrical body 10 is assembled within the internal space 30 of the nozzle case 2.

The nozzle case 2 will now be described with reference to FIG. 4. The nozzle case 2 has a cylindrical tubular configuration and serves to receive the pellets P pushed into the internal space 30 and to melt the pellets P into the molten resin M. To this end, the base end side (lower side as viewed in FIG. 4) of the internal space 30 is opened to enable the pusher to push the pellets P into the internal space 30. The front end side (upper side as viewed in FIG. 4) of the internal space 30 is also opened to allow injection of the molten resin M.

The front end side of the internal space 30 of the nozzle case 2 is tapered to enable injection of the molten resin M at a high pressure. A ring 32 is mounted within the internal space 30 for preventing the torpedo 1 from being removed from within the internal space 30.

A band heater 34 is attached to the outer circumferential surface of the nozzle case 2 in order to heat the nozzle case 2, so that the pellets P fed into the internal space 30 can be heated and melted into the molten resin M. In this way, the internal space 30 serves as a passage for the pellets P and the molten resin M resulted from the pellets P.

The mold 3 will now be described. The mold 3 serves to define a cavity 40 between the mold 3 and a mating mold 4 that can be moved relative to the mold 3 for opening and closing the cavity 40. The mold 3 is mounted to the front end of the nozzle case 2 by a suitable coupling device (not shown).

The gate 42 is formed in the mold 3 for communicating between the cavity 40 and the front side region of the internal space 30 of the nozzle case 2 when the mold 3 is mounted to the nozzle case 2. As described previously, the needle pin 20 normally closes the gate 42.

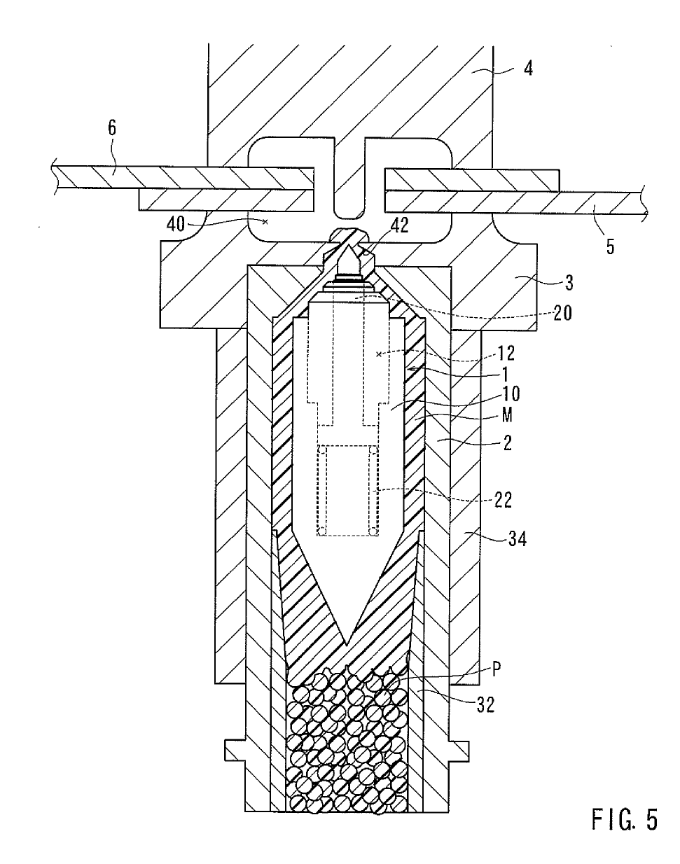

The operation of the direct molding machine will now be described with reference to FIGS. 4 and 5. First, in the state shown in FIG. 4, the plunger (not shown) is operated to push the pellets P into the internal space 30 of the nozzle case 2 from its lower side as viewed in FIG. 4.

Therefore, the pellets P are fed into the gap F and are melted into the molten resin M by the heat of the band heater 34. In other words, the pellets P are plasticized. The pellets P fed into the gap F may contact the blades 14, so that a pressure applied to the pellets P may be increased, resulting in improvement of the plasticization efficiency of the pellets P.

As the pellets P are fed into the gap F, the pressure applied to the molten resin M increases to exceed a predetermined high pressure, so that the needle pin 20 retreats against the biasing force of the compression spring 22 to open the gate 42 of the mold 3. Then, the molten resin M is injected into the cavity 40 via the gate 42. The amount of the molten resin M injected into the cavity 40 during one stroke of the plunger is set to correspond to the volume of the cavity 40. Therefore, the pressure of the injected molten resin M decreases upon completion of injection of the molten resin M. Then, the needle pin 20 returns to the close state shown in FIG. 4, where the needle pin 20 closes the gate 42 by the biasing force of the compression spring 22. As the needle pin 20 returns to the close position, the molten resin M injected into the cavity 40 is separated from the molten resin M within the nozzle case 2.

In this specification, the term “direct molding machine” is used to mean an injection molding machine that is configured to form a cavity (the cavity 40 in this example) with a primary molded product (primary molded resin products 5 and 6 shown in FIGS. 4 and 5 in this example) positioned between mold parts (the molds 3 and 4 in this example), so that a secondary molded product (secondary molded resin product formed by the injected molten resin M) is directly integrally formed with the primary molded product. The direct molding machine is advantageous because the secondary molded product can be formed at any position of the primary molded product (the products 5 and 6 in this example) with a desired shape without need of change to the mold for molding the primary molded product. In addition, the direct molding machine can mold a connecting member on two primary molded products (the products 5 and 6 in this example) for connecting the two primary molded products in place of using a separate connecting device. Therefore, it is possible to connect the two products at a lower cost without need of a management cost that may be required in the case of use of a separate connecting device.

According to the torpedo 1 of the above example, the fifth blade 14e, the sixth blade 14f, the seventh blade 14g and the eighth blade 14h are displaced from the first blade 14a, the second blade 14b, the third blade 14c and the fourth blade 14d by an angle of 45° in the circumferential direction of the cylindrical body 10, respectively. Therefore, the pellets P fed into the gap F can contact with many of the blades 14 (eight blades in this example), so that it is possible to increase the contact area of the blades 14 for contacting with the pellets P. Hence, it is possible to increase the pressure that may be applied to the pellets P, resulting in improvement of the plasticization efficiency of the pellets P. In addition, because each of the blades 14 has a simple linear shape, it is possible to easily form the blades 14.

### Second Example

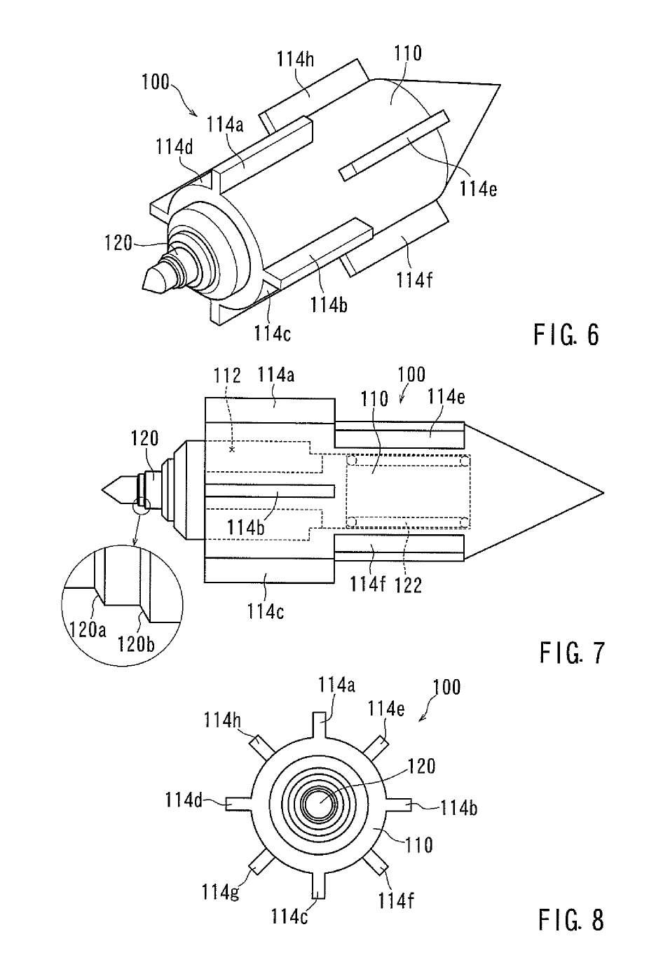

A second example will now be described with reference to FIGS. 6 to 10. Referring to FIGS. 6 to 9, there are shown a torpedo 101 serving as an injection device for a direct molding machine (not shown), a nozzle case 102 into which the torpedo 101 can be assembled, and a mold 103 mounted to a front end of the nozzle case 102.

The torpedo 101 will be first described. The torpedo 101 has a substantially cylindrical body 110 and a needle pin 120. The needle pin 120 is axially movably received within the cylindrical body 110 and can extend from and retract into a front end of the cylindrical body 110.

As shown in FIGS. 6 and 7, a bottomed insertion hole 112 is formed within the front end portion (positioned on the side for injecting a molten resin M) of the cylindrical body 110 and extends in the axial direction thereof. The needle pin 120 is axially movably received within the insertion hole 112. A plurality of blades 114 are formed on the outer circumferential surface of the cylindrical body 110. In this example, eight blades 114 including a first blade 114a, a second blade 114b, a third blade 114c, a fourth blade 114d, a fifth blade 114e, a sixth blade 114f, a seventh blade 114g and an eighth blade 114h are formed. Each of the blades 114 has a shape of a flat plate that is rectangular as viewed in the circumferential direction of the cylindrical body 110. Each of the blades 114 extends linearly in the axial direction of the cylindrical body 110 and protrudes radially outwardly from the outer circumferential surface of the cylindrical body 110.

The first to fourth blades 114a to 114d of the eight blades 114 are formed to extend only within a region between the front end and a substantially central position with respect to the axial direction of the cylindrical body 110. In addition, the first to fourth blades 114a to 114d are spaced equally from each other (by an angle of 90°) in the circumferential direction of the cylindrical body 110.

For example, as shown in FIG. 8, the first blade 114a may be positioned to correspond to 0:00 position of the hour hand of a clock, the second blade 114b may be positioned to correspond to 3:00 position of the hour hand, the third blade 114c may be positioned to correspond to 6:00 position of the hour hand, and the fourth blade 114d may be positioned to correspond to 9:00 position of the hour hand.

On the other hand, the fifth to eighth blades 114e to 114h of the eight blades 114 are formed to extend only within a region between the base end (positioned on the side for feeding pellets P) and the substantially central position with respect to the axial direction of the cylindrical body 110. In addition, similar to the first to fourth blades 114a to 114d, the fifth to eighth blades 114e to 114h are spaced equally from each other (by an angle of 90°) in the circumferential direction of the cylindrical body 110.

Further, the fifth blade 114e, the sixth blade 114f, the seventh blade 114g and the eighth blade 114 are displaced from the first blade 114a, the second blade 114b, the third blade 114c and the fourth blade 114d in the circumferential direction by an angle of 45°, respectively.

Thus, the fifth blade 114e is positioned to correspond to 1:30 position of the hour hand, the sixth blade 114f is positioned to correspond to 4:30 position of the hour hand, the seventh blade 114g is positioned to correspond to 7:30 position of the hour hand, and the eighth blade 114h is positioned to correspond to 10:30 position of the hour hand, in the case that the first blade 114a is positioned to correspond to 0:00 position of the hour hand, the second blade 114b is positioned to correspond to 3:00 position of the hour hand, the third blade 114c is positioned to correspond to 6:00 position of the hour hand, and the fourth blade 114d is positioned to correspond to 9:00 position of the hour hand as described above.

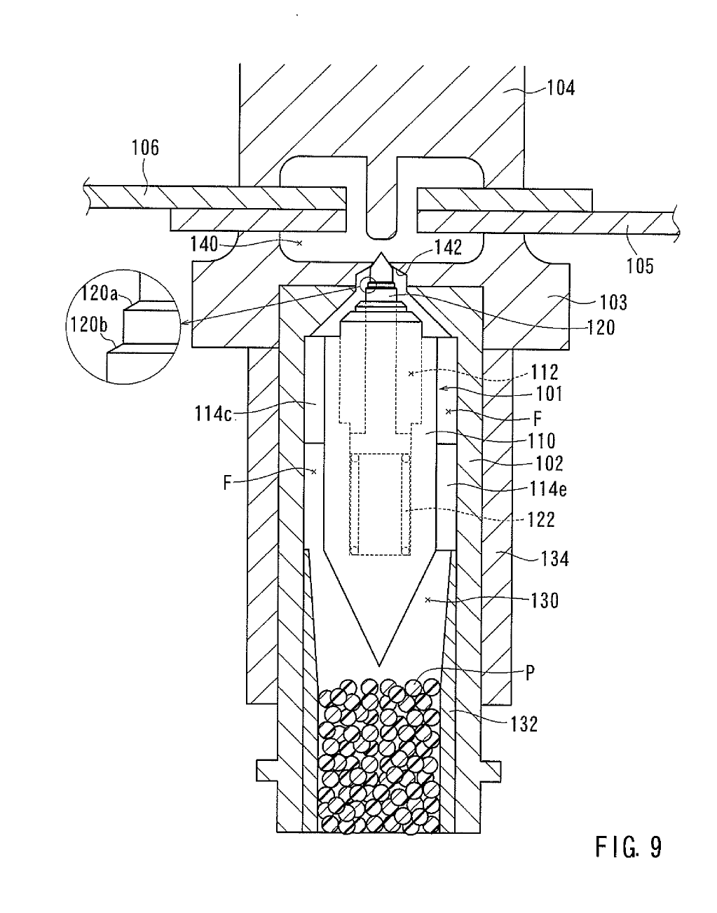

The above eight blades 114 serve as a slide mechanism when the cylindrical body 110 is assembled within an internal space 130 defined in the nozzle case 102 as shown in FIG. 9.

As described above, the eight blades 114 are formed only at 0:00 position, 3:00 position, 6:00 position, 9:00 position, 1:30 position, 4:30 position and 10:00 position of the hour hand. In other words, these blades 114 are not formed to extend throughout the entire circumference (360°) around the cylindrical body 10. Therefore, a gap F is ensured at positions where no blade 114 exists. In this way, the blades 114 are formed such that the gap F is ensured between the inner wall of the internal space 130 of the nozzle case 102 and the outer circumferential surface of the cylindrical body 110.

A portion of the cylindrical body 110 on the side of the base end is tapered, so that the pellets P can be smoothly fed from within the internal space 130 of the nozzle case 102 into the gap F.

As described previously, the needle pin 120 is inserted into the insertion hole 112 formed in the cylindrical body 110. The needle pin 120 has a front end portion having a tapered front end for contacting with the peripheral edge of the opening of the gate 142, where the gate 142 is opened into the cavity 140 (see FIG. 9). In addition, the front end portion of the needle pin 120 proximal to the tapered front end has two stepped portions including a first stepped portion 120a and a second stepped portion 120b as shown in FIGS. 7 and 9. The inclination angles of the first and second stepped portions 120a and 120b are determined to enable the needle pin 120 to easily open a gate 142 when the needle pin 120 receives the injection pressure of the molten resin M. The inclination angles of the first and second stepped portions 120a and 120b may be the same or different from each other.

A compression spring 122 is interposed between the base end of the needle pin 120 and the bottom of the insertion hole 112. A removal preventing mechanism (not shown) is provided for preventing the needle pin 120 from being removed from within the insertion hole 112.

The needle pin 120 is sized such that the front end of the needle pin 120 can close the gate 142 of the mold 103 for preventing flow of the molten resin M from the gate 142 during a normal condition (i.e., during the time when the pellets P are not pushed by a plunger (not shown)) when the cylindrical body 110 is assembled within the internal space 130 of the nozzle case 102.

The nozzle case 102 will now be described with reference to FIG. 9. The nozzle case 102 has a cylindrical tubular configuration and serves to receive the pellets P pushed into the internal space 130 and to meld the pallets P into the molten resin M. To this end, the base end side (lower side as viewed in FIG. 9) of the internal space 130 is opened to enable the pusher to push the pellets P into the internal space 130. The front end side (upper side as viewed in FIG. 9) of the internal space 30 is also opened to allow injection of the molten resin M.

The front end side of the internal space 130 of the nozzle case 102 is tapered to enable injection of the molten resin M at a high pressure. A ring 132 is mounted within the internal space 130 for preventing the torpedo 101 from being removed from within the internal space 130.

A band heater 134 is attached to the outer circumferential surface of the nozzle case 102 in order to heat the nozzle case 102, so that the pellets P fed into the internal space 130 can be heated and melted into the molten resin M. In this way, the internal space 130 serves as a passage for the pellets P and the molten resin M resulted from the pellets P.

The mold 103 will now be described. The mold 103 serves to define a cavity 140 between the mold 103 and a mating mold 104 that can be moved relative to the mold 103 for opening and closing the cavity 140. The mold 103 is mounted to the front end of the nozzle case 102 by a suitable coupling device (not shown).

The gate 142 is formed in the mold 103 for communicating between the cavity 140 and the front side region of the internal space 130 of the nozzle case 102 when the mold 103 is mounted to the nozzle case 102. As described previously, the needle pin 120 normally closes the gate 142.

In this way, the injection section of the direct molding machine is formed by the torpedo 101, the nozzle case 102 and the mold 103.

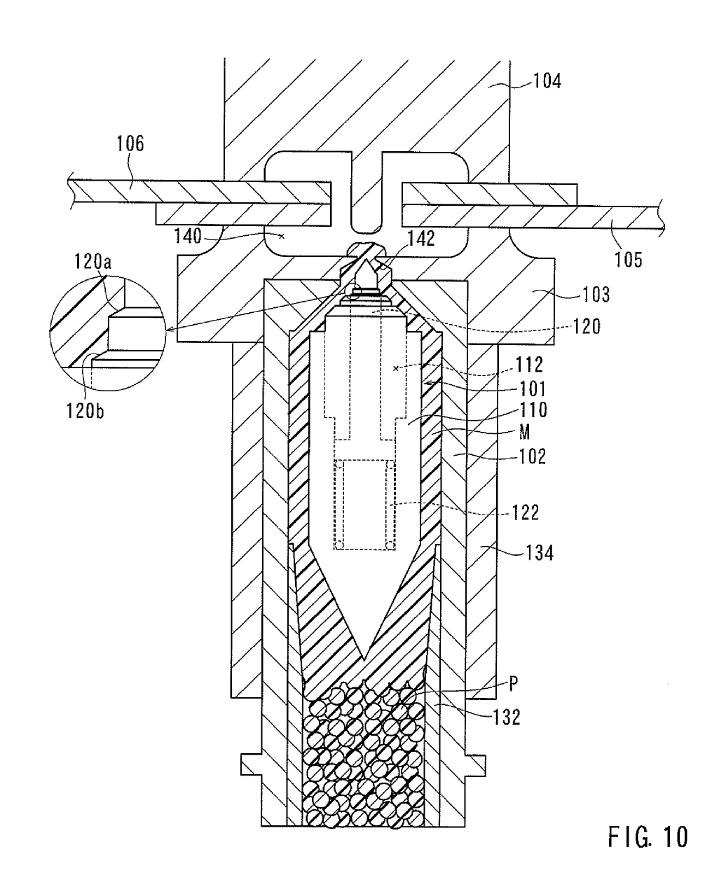

The operation of the direct molding machine will now be described with reference to FIGS. 9 and 10. First, in the state shown in FIG. 9, the plunger (not shown) is operated to push the pellets P into the internal space 130 of the nozzle case 102 from the lower side of the nozzle case 102 as viewed in FIG. 9.

Therefore, the pellets P are fed into the gap F and are melted into the molten resin M by the heat of the band heater 134. In other words, the pellets P are plasticized. The pellets P fed into the gap F may contact the blades 114, so that a pressure applied to the pellets P may be increased, resulting in improvement of the plasticization efficiency of the pellets P.

As the pellets P are fed into the gap F, the pressure applied to the molten resin M increases to exceed a predetermined high pressure, so that the needle pin 120 retreats against the biasing force of the compression spring 122 to open the gate 142 of the mold 103. Then, the molten resin M is injected into the cavity 140 via the gate 142 (see FIG. 10). The amount of the molten resin M injected into the cavity 140 during one stroke of the plunger is set to correspond to the volume of the cavity 140. Therefore, the pressure of the injected molten resin M decreases upon completion of injection of the molten resin M. Then, the needle pin 120 returns to the close state shown in FIG. 9, where the needle pin 120 closes the gate 142 by the biasing force of the compression spring 122. As the needle pin 120 returns to the close position, the molten resin M injected into the cavity 140 is separated from the molten resin M within the nozzle case 102.

According to the torpedo 101 of the above example, the front end portion of the needle pin 120 has the first stepped portion 120a and the second stepped portion 120b. The inclination angles of the first and second stepped portions 120a and 120b are determined to enable the needle pin 120 to easily open the gate 142 when the needle pin 120 receives the injection pressure of the molten resin M. In other words, due to the inclinations of the first and second stepped portions 120a and 120b, the pressure of the molten resin M applied to each of the first and second stepped portions 120a and 120b may produce a force to retreat the needle pin 120 against the biasing force of the compression spring 122. Therefore, even in the case that the injection pressure is relatively small or the size of the plunger for producing the injection pressure is relatively small, it s possible to retreat the needle pin 120 against the basing force of the compression spring 122. As a result, it is possible to smoothly open the gate 142 for communication with the cavity 140.

### Possible Modifications of First and Second Examples

The above examples may be modified in various ways. In the first example, the first to fourth blades 14a to 14d of the eight blades 14 are formed to extend only within a region between the front end and a substantially central position with respect to the axial direction of the cylindrical body 10, and the fifth to eighth blades 14e to 14h of the eight blades 14 are formed to extend only within a region between the base end (positioned on the side of feeding pellets P) and the substantially central position with respect to the axial direction of the cylindrical body 10. In other words, four blades 14 are formed on each of the front end side and the base end side of the cylindrical body 10. However, the number of the blades 14 on each side may not be limited to four and may be three or less or five or more.

Further although the first to fourth blades 14a to 14d are formed to extend only within a region between the front end and a substantially central position with respect to the axial direction of the cylindrical body 10, one or more or all of the first to fourth blades 14a to 14d may extend beyond the central position. For example, one or more or all of the first to fourth blades 14a to 14d may extend throughout the axial length of the cylindrical body 10.

Further, although each of the blades 14 has a rectangular configuration as viewed in the circumferential direction of the cylindrical body 10 (see FIG. 3), the configuration of the blades 14 may not be limited to the rectangular configuration but may be an elliptical configuration, a substantially square configuration or any other suitable configuration.

In the second example, the tapered portion of the needle pin 120 is configured to have two stepped portions including the first stepped portion 120a and the second stepped portion 120b. However, the number of the stepped portions may be one or three or more.

Further although the first to fourth blades 114a to 114d are formed to extend only within a region between the front end and a substantially central position with respect to the axial direction of the cylindrical body 110, one or more of the first to fourth blades 114a to 114d may extend beyond the central position. For example, one or more of the first to fourth blades 114a to 114d may extend throughout the axial length of the cylindrical body 110.

Further, although each of the blades 114 has a rectangular configuration as viewed in the circumferential direction of the cylindrical body 110 (see FIG. 8), the configuration of the blades 114 may not be limited to the rectangular configuration but may be an elliptical configuration, a substantially square configuration or any other suitable configuration.

Further, although the body (10, 110) of the torpedo (1, 101) has a substantially cylindrical configuration, the body may have the other configuration than the cylindrical configuration. For example, the body may have a prismatic configuration.

Further, although each of the blades (14, 114) extends linearly in the axial direction of the cylindrical body (10, 110), each of the blades may extend along a curved line.

Further, the features of the torpedo 1 of the first example and the features of the torpedo 101 of the second example may be combined. For example, the body 10 of the first example may be combined with the needle pin 120 of the second example.

What is claimed is:

1. A torpedo comprising:
a body having a substantially cylindrical configuration;
a plurality of blades formed on an outer circumferential surface of the body;
wherein the plurality of blades are arranged to ensure a gap between the outer circumferential surface of the body and an inner circumferential wall of an internal space of a nozzle case when the body is received within the internal space of the nozzle case; and
a needle pin received within the body and axially movable to extend from and retract into a front portion of the body;
wherein when a pressure of a molten resin melted from pellets fed into the gap exceeds a predetermined pressure, the needle pin can open a gate of a mold mounted to the nozzle case, the mold defining a cavity communicating with the gate;
wherein the plurality of blades comprise a first group of blades and a second group of blades;
wherein the first group of blades is positioned on one side with respect to a middle position in an axial direction of the body, the blades in the first group being spaced substantially equally from each other in a circumferential direction of the body; and
wherein the second group of blades is positioned on the other side with respect to the middle position, the blades in the second group being spaced substantially equally from each other in the circumferential direction of the body and positioned to be displaced in the circumferential direction from the blades in the first group.

2. The torpedo as in claim 1, wherein each of the first group of blades and the second group of blades include four or more blades.

3. The torpedo as in claim 1, wherein each of the blades in the first and second groups extends substantially linearly in the axial direction of the body.

4. The torpedo as in claim 3, wherein each of the blades in the first and second groups protrudes radially outwardly from the outer circumferential surface of the body;

5. The torpedo as in claim 4, wherein each of the blades has a substantially rectangular configuration.

6. The torpedo as in claim 1, wherein the blades in the first group are the same in number as the blades in the second group, and each of the blades in the second group is positioned between two adjacent blades in the first group with respect to the circumferential direction.

7. The torpedo as in claim 1, wherein the needle pin has at least one stepped portion that can receive the pressure of the molten resin to produce a force for moving the needle pin in a direction for opening the gate.

8. The torpedo as in claim 7, wherein the needle pin has two or more stepped portions.

9. The torpedo as in claim 7, wherein the at least one stepped portion is formed on a front end portion of the needle pin and has a surface tapered toward a front end of the needle pin.

10. The torpedo as in claim 7, further comprising a spring biasing the needle pin in a direction opposite to the direction for opening the gate.

11. A torpedo comprising:
a body having a plurality of blades formed on an outer circumferential surface of the body; and
a needle pin received within the body and axially movable to extend from and retract into a front portion of the body;
wherein the plurality of blades are arranged to ensure a gap between the outer circumferential surface of the body and an inner circumferential wall of an internal space of a nozzle case for receiving a supply of a molten material when the body is received within the internal space;
wherein the blades are formed separately each other.

12. The torpedo as in claim 11, wherein each of the blades extends linearly in an axial direction of the body.

13. A torpedo comprising:
a body; and
a needle pin received within the body and axially movable relative to the body;
wherein the needle pin has at least one stepped portion for receiving a pressure of a molten material to produce a force for moving the needle pin in an axial direction when the body is received within a nozzle case into which the molten material is supplied.

14. The torpedo as in claim 13, wherein the needle pin has two or more stepped portions.

15. The torpedo as in claim 13, wherein the at least one stepped portion is formed on a front end portion of the needle pin and has a surface tapered toward a front end of the needle pin.
